(19) United States
(12) Patent Application Publication
(10) Pub. No.: US 2018/0100362 A1
(43) Pub. Date: Apr. 12, 2018

(54) Electronically-Controlled Compressed Air System

(71) Applicant: Caterpillar Global Mining Equipment LLC, Denison, TX (US)

(72) Inventors: Rick William Berlage, Washington, IL (US); Christopher Michal Ruemelin, Peoria, IL (US); Brian Daniel Rockwood, Washington, IL (US); Jerry E. Berkeland, Melissa, TX (US)

(73) Assignee: Caterpillar Global Mining Equipment LLC, Denison, TX (US)

(21) Appl. No.: 15/291,544

(22) Filed: Oct. 12, 2016

(51) Int. Cl. E21B 21/16; F02B 63/06; E21B 21/01; F17C 1/00

(52) U.S. Cl. CPC E21B 21/16; F02B 63/06; E21B 7/02; F17C 1/00; E21B 21/01

(57) ABSTRACT

A compressed air system for a machine is disclosed. The compressed air system may comprise an air compressor having an inlet, an inlet valve configured to regulate a flow of air to the inlet of the air compressor, a reservoir configured to store compressed air generated by the air compressor, and a reservoir pressure sensor configured to monitor an actual reservoir pressure of the compressed air stored in the reservoir. The system may further comprise an electronic control system configured to regulate a position of the inlet valve. The electronic control system may include an electronic control module (ECM) in electronic communication with the reservoir pressure sensor and an electronic actuator operatively associated with the inlet valve to adjust the position of the inlet valve.

### TECHNICAL FIELD

The present disclosure generally relates to compressed air systems and, more specifically, compressed air systems having electronically controlled valves.

### BACKGROUND

Many machines and equipment include compressed air systems that provide compressed air to perform various functions. Such compressed air systems may include an air compressor that is driven by an engine of the machine, an inlet valve that regulates airflow to an inlet of the air compressor, and a receiver tank that stores the compressed air generated by the air compressor. For example, drill machines (such as track drill machines), surface rock drills, and rotary drill machines may supply compressed air down a drill rod to flush dust out of a hole as the hole is being drilled by the drill rod. Such machines may also rely on compressed air to perform such functions as driving the flow of lubricating oil through the air compressor, and intermittently cleaning filters of a dust collector which collect the dust of the material that is flushed out of the hole. To perform such functions, compressed air may be directed to various downstream sites (e.g., the drill rod, the dust collector filter, etc.) from the receiver tank.

To support the downstream functions of the machine that rely on compressed air, the pressure of the compressed air in the receiver tank may be carefully regulated. In current designs of some machines (including drill machines), the pressure of the compressed air in the receiver tank may be controlled by pneumatic regulation of the inlet valve to the air compressor to increase or decrease the outflow of the compressed air from the air compressor that is used charge the receiver tank. For example, a pneumatic cylinder may be connected to the inlet valve for control of the open or closed position of the inlet valve. Some pneumatically controlled systems may open the inlet valve completely even when relatively light pressure demands (e.g., when “collaring a hole” or starting to drill a hole) are placed on the system such that the receiver tank may be unnecessarily charged to a high pressure. Thus, pneumatic regulation of the inlet valve may be inefficient as it may unnecessarily increase the load on the engine (which drives the compressor) and fuel consumption.

U.S. Pat. No. 5,409,072 (hereinafter the ‘072 patent’) discloses a method for controlling the amount of flushing air supplied to a rock drilling machine, wherein the amount of air is increased when full drilling power is not used due to the abundance of earth or the softness of rock. Specifically, the '072 patent discloses a method in which the air supply of an air compressor is adjusted so that when the percussion pressure of a percussion device of the rock drilling machine is high, the amount of air supplied by the compressor is small, and vice versa. However, there is still a need for dynamic control of air compressor systems according to the varying pressure demands on the air compressor system.

### SUMMARY

In accordance with one aspect of the present disclosure, a compressed air system for a machine is disclosed. The compressed air system may comprise an air compressor having an inlet, an inlet valve configured to regulate a flow of air to the inlet, a reservoir configured to store compressed air generated by the air compressor, and a reservoir pressure sensor configured to monitor an actual reservoir pressure of the compressed air stored in the reservoir. The compressed air system may further comprise an electronic control system configured to regulate a position of the inlet valve. The electronic control system may include an electronic control module (ECM) in electronic communication with the reservoir pressure sensor and an electronic actuator operatively associated with the inlet valve to adjust the position of the inlet valve. The ECM may be configured to transmit an open valve command to the electronic actuator when the actual reservoir pressure is below a target reservoir pressure so that the electronic actuator at least partially opens the inlet valve. The ECM may be further configured to transmit a close valve command to the electronic actuator when the actual reservoir pressure is above the target reservoir pressure so that the electronic actuator at least partially closes the inlet valve.

In accordance with another aspect of the present disclosure, a method for controlling an inlet valve to an air compressor of a compressed air system of a machine is disclosed. The compressed air system may comprise a reservoir configured to store compressed air from the air compressor, and a reservoir pressure sensor configured to monitor an actual reservoir pressure of the compressed air stored in the reservoir. The method may comprise determining a target reservoir pressure for the compressed air stored in the reservoir, and determining a pressure difference between the target reservoir pressure and the actual reservoir pressure. The method may further comprise transmitting an open valve command to an electronic actuator when the actual reservoir pressure is below the target reservoir pressure so that the electronic actuator opens the inlet valve by a degree that is proportional to the pressure difference, and transmitting a close valve command to the electronic actuator when the actual reservoir pressure is above the target reservoir pressure so that the electronic actuator closes the inlet valve by a degree that is proportional to the pressure difference.

In accordance with another aspect of the present disclosure, a drill machine is disclosed. The drill machine may comprise an internal combustion engine and at least one drill rod. The drill machine may further comprise a compressed air system configured to deliver compressed air to the drill rod when drilling is active. The compressed air system may include an air compressor driven by the engine and having an inlet, a butterfly valve configured to regulate a flow of air into the inlet, a reservoir configured to store the compressed air generated by the air compressor, and a reservoir pressure sensor configured to monitor an actual reservoir pressure of the compressed air stored in the reservoir. The drill machine may further include an electronic actuator operatively associated with the butterfly valve to control a position of the butterfly valve, and an electronic control module (ECM) in electronic communication with the reservoir pressure sensor and the electronic actuator. The ECM may be configured to determine a target reservoir pressure, transmit an open valve command to the electronic actuator when the actual reservoir pressure is below the target reservoir pressure so that the electronic actuator at least partially opens the butterfly valve, and transmit a close valve command to the electronic actuator when the actual reservoir pressure is above the target reservoir pressure so that the electronic actuator at least partially closes the butterfly valve.

These and other aspects and features of the present disclosure will be more readily understood when read in conjunction with the accompanying drawings.

### BRIEF DESCRIPTION OF THE DRAWINGS

FIG. 1 is a side perspective view of a machine having a compressed air system, constructed in accordance with the present disclosure;

FIG. 2 is another side perspective view of the machine of FIG. 1, constructed in accordance with the present disclosure;

FIG. 3 is a perspective view of some of the components of the compressed air system, constructed in accordance with the present disclosure;

FIG. 4 is a perspective view of the compressed air system of FIG. 3 with some components removed for clarity, constructed in accordance with the present disclosure;

FIG. 5 is a perspective view of an electronic actuator of the compressed air system, constructed in accordance with the present disclosure;

FIG. 6 is a schematic representation of an electronic control system for the compressed air system, in accordance with the present disclosure;

FIG. 7 is a schematic block diagram of a strategy for regulating an inlet valve to an air compressor of the compressed air system as implemented by an electronic control module (ECM) of the electronic control system, in accordance with the present disclosure;

FIG. 8 is a flowchart of an exemplary method for determining a target reservoir pressure for a reservoir of the compressed air system as implemented by the ECM, in accordance with a method of the present disclosure;

FIG. 9 is a flowchart of an exemplary method for controlling an open or closed position of the inlet valve as implemented by the ECM, in accordance with a method of the present disclosure; and

FIG. 10 is a flowchart of an exemplary method of regulating the inlet valve to the air compressor as implemented by the electronic control system, in accordance with a method of the present disclosure;

### DETAILED DESCRIPTION

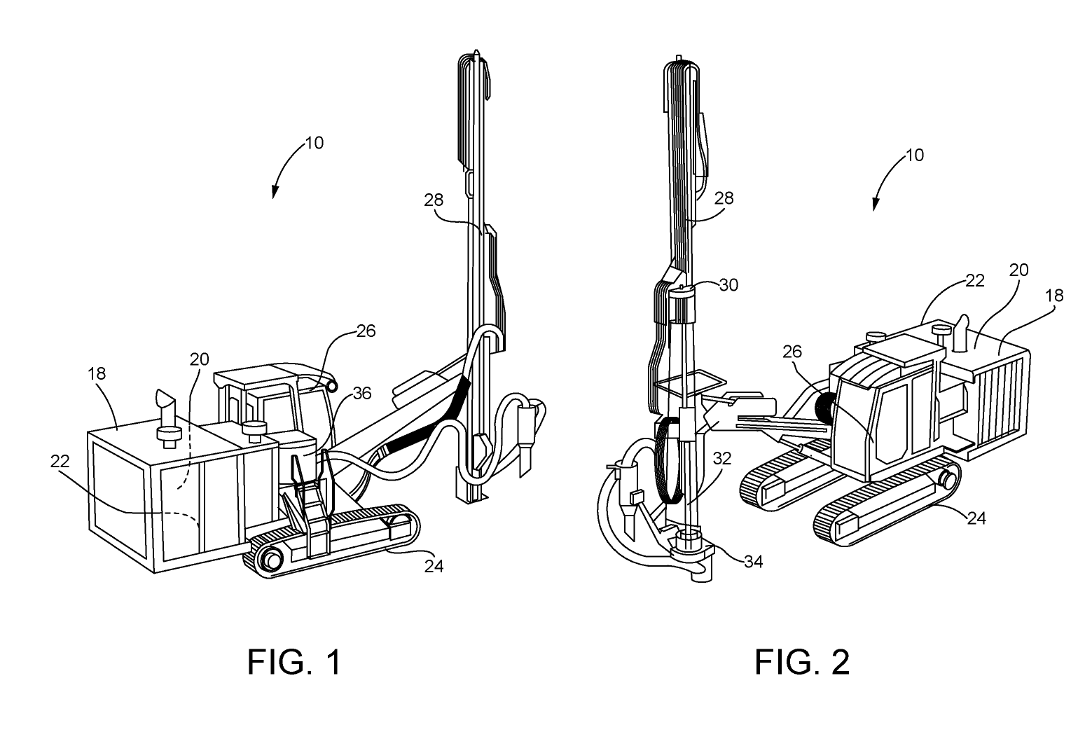

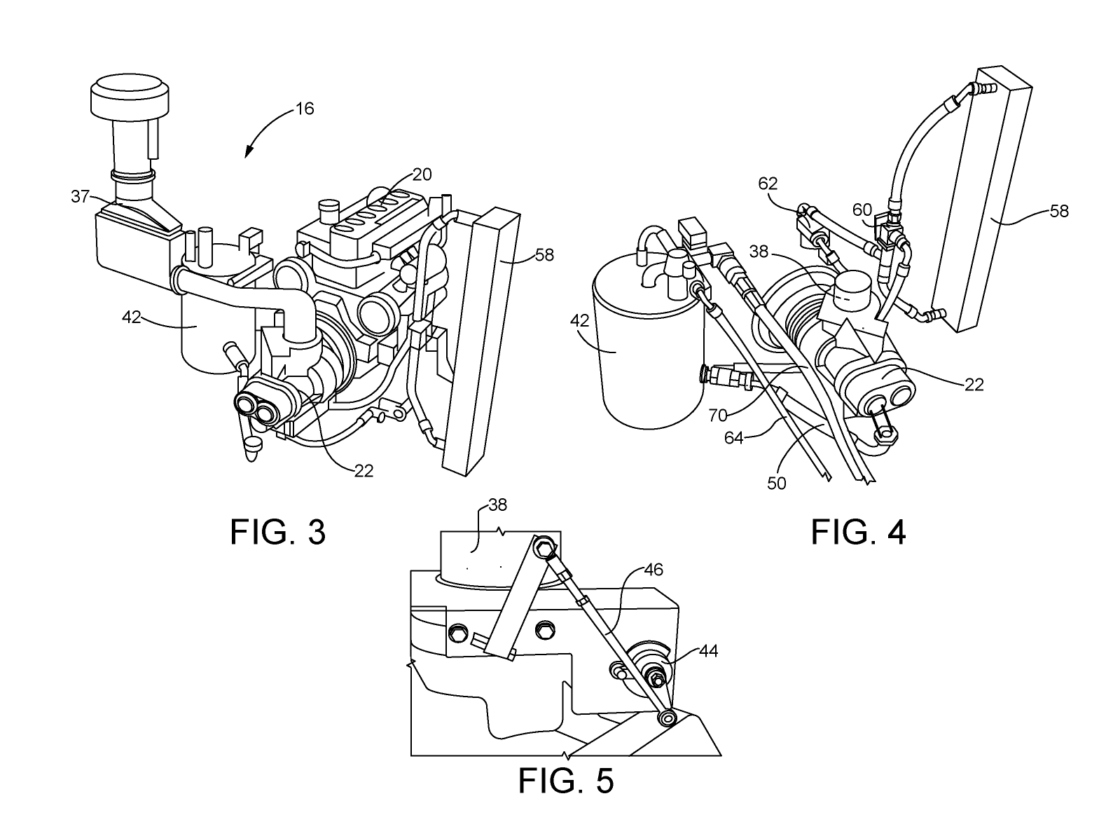

Referring now to the drawings, and with specific reference to FIGS. 1-2, a machine 10 relying on compressed air to perform one or more operations is shown. As non-limiting examples, the machine 10 may be a drill machine such as a track drill machine or a rotary drill machine, as shown. As will be understood by those with ordinary skill in the art, a track drill machine and a rotary drill machine may have similar or nearly identical features, with the rotary drill machine being larger than the track drill machine. As such, FIGS. 1-2 as well as the following description of the machine 10 apply to both the track drill machine and the rotary drill machine, but will be referred to as the machine 10 throughout the description for simplicity. Alternatively, the machine 10 may be any other type of mobile or stationary machine or equipment that uses compressed air to perform one or more operations. The machine 10 may include a compressed air system 16 (see FIG. 3) that generates the compressed air and delivers the compressed air to various downstream sites as discussed in further detail below.

Referring still to FIGS. 1-2, the machine 10 may include an enclosure 18 containing an internal combustion engine 20, and an air compressor 22 that is driven by the engine 20 and that produces the compressed air (also see FIG. 3). The air compressor 22 may be a rotary screw compressor, although other types of suitable air compressors may also be used in some cases. In addition, the machine 10 may include tracks 24 to facilitate movement of the machine 10, and an operator cab 26. In some implementations, the machine 10 may be an unmanned machine with other arrangements. Furthermore, the machine 10 may have a mast 28 supporting a carousel 30 that carries one or more drill rods 32. Each of the drill rods 32 may have a drill bit 34 configured to drill a hole into a material or structure such as rock, earth, or other natural or man-made materials or structures. During drilling, compressed air from the air compressor 22 may be flowed through the drill rod 32 to flush dust or chips of the material out of the hole that is being drilled. The machine 10 may also include a dust collector 36 that pulls a vacuum to collect the dust that is blown out of the hole on one or more filters as the hole is being drilled. Periodically, compressed air from the air compressor 22 may be supplied to the dust collector 36 to clean the filters during a cleaning cycle of the machine 10, as will be described in further detail.

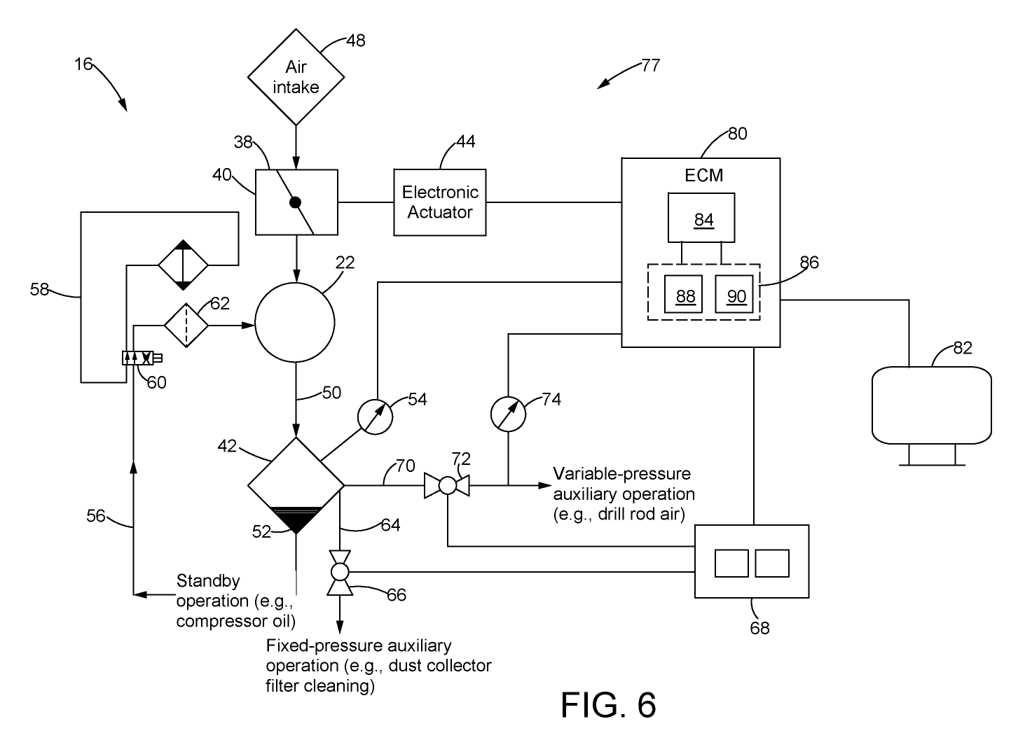

FIGS. 3-5 illustrate some of the components of the compressed air system 16 of the machine 10. As shown in FIG. 3, the compressed air system 16 may include the air compressor 22 having an inlet 37 through which air from the external environment may enter the air compressor 22. As shown in FIG. 4, positioned along the inlet 37 may be an inlet valve 38 that regulates the flow of the air into the air compressor 22. As shown in FIG. 6, in some embodiments, the inlet valve 38 may be a butterfly valve 40. Alternatively, the valve 38 may be another type of valve apparent to those with ordinary skill in the art such as, but not limited to, a ball valve, a diaphragm valve, a needle valve, a check valve, and a plug valve.

Referring back to FIGS. 3 and 4, the compressed air system 16 may also include a reservoir 42 to store the compressed air generated by the air compressor 22. The pressure of the compressed air, in the reservoir 42, may be regulated to a target reservoir pressure that may vary according to compressed air needs of the machine 10. As used herein, a “target reservoir pressure” may refer to a targeted pressure of compressed air in the reservoir 42 sufficient to support the active operations (of the machine 10) that use compressed air. As shown in FIG. 5, to ensure that the pressure of the compressed air in the reservoir 42 is at the target reservoir pressure, the position of the inlet valve 38 may be controlled with an electronic actuator 44. The electronic actuator 44 may be directly coupled to the inlet valve 38 or, optionally, it may be mechanically coupled to the inlet valve 38 through a mechanical link 46, as shown in FIG. 5. The mechanical link 46 may adjust the degree of opening of the inlet valve 38, as well as increase the applied torque on the inlet valve 38. For example, if the electronic actuator 44 rotates 120°, the mechanical link 46 may adjust the degree of rotation of the inlet valve 38 to 90° for opening. In one example, the mechanical link 46 may be a four-bar linkage, although other types of mechanical linkages may also be used.

Turning now to FIG. 6, a schematic representation of the compressed air system 16 is shown. In operation, an air intake device 48 may draw in air from the external environment and direct the air to the inlet valve 38. If at least partially open, the inlet valve 38 may permit the flow of the air to the air compressor 22 which may compress the air and increase its pressure according to mechanisms well understood by those with ordinary skill in the art. Referring back to FIG. 4, the compressed air generated by the air compressor 22 may then be directed to the reservoir 42 through one or more charging lines 50. The reservoir 42 may also store oil 52 that is used to lubricate the air compressor 22. Associated with the reservoir 42 may be a reservoir pressure sensor 54 that monitors the pressure of the compressed air in the reservoir, or the “actual reservoir pressure.”

The compressed air stored in the reservoir 42 may be delivered to one or more downstream sites to support one or more operations of the machine 10. For example, the compressed air stored in the reservoir 42 may be used to perform one or more standby operations at a fixed standby pressure. As used herein, a “standby operation” may be an operation that is performed constantly during the operation of the machine 10. In addition, as used herein, a “fixed standby pressure” may be a predetermined and fixed pressure of the compressed air that is used to carry out the standby operation. For example, the standby operation may be the delivery of the oil 52 to the to the air compressor 22 through one or more standby service lines 56 for lubrication of the air compressor 22. In this example, the oil 52 flowing through the service line 56 may enter an oil cooler 58 through a thermal valve 60 if the temperature of the oil is too high before passing through an oil filter 62 and is directed to the air compressor 22 (also see FIG. 4). Alternatively, if the temperature of the oil 52 is not too high, it may be directly passed through the oil filter 62 and to the air compressor 22.

The compressed air stored in the reservoir 42 may also be used to perform one or more fixed-pressure auxiliary operations at a fixed auxiliary pressure. As used herein, a “fixed-pressure auxiliary operation” may be an operation that is performed intermittently during the operation of the machine, and a “fixed auxiliary pressure” may be a predetermined and fixed pressure of the compressed air that is used to carry out the fixed-pressure auxiliary operation. Accordingly, the “fixed-pressure auxiliary operation” may be active or inactive at any given time during the operation of the machine 10. The compressed air that is used for the fixed-pressure auxiliary operation may be delivered to a target downstream site through one or more auxiliary service lines 64. As a non-limiting example, the fixed-pressure auxiliary operation may be the delivery of the compressed air to the dust collector 36 to clean the filter(s) of the dust collector 36 during the cleaning cycle of the machine 10. The fixed-pressure auxiliary operation may be activated or inactivated with a valve 66 using an operator control 68, such as one or more buttons on a keypad or a joystick. Alternatively, the fixed-pressure auxiliary operation may be activated and inactivated automatically.

Furthermore, the compressed air stored in the reservoir 42 may be used to perform one or more variable-pressure auxiliary operations at a variable auxiliary pressure. As used herein, a “variable-pressure auxiliary operation” is an operation that is performed periodically or intermittently during the operation of the machine 10, and a “variable auxiliary pressure” is a variable pressure of the compressed air that is used to perform the variable-pressure auxiliary operation. Thus, the variable-pressure auxiliary operation may be active or inactive at any given time during the operation of the machine 10. The compressed air that is used to perform the variable-pressure auxiliary operation may be delivered to a target downstream site through one or more auxiliary service lines 70 (also see FIG. 4). For example, the variable-pressure auxiliary operation may be the delivery of the compressed air down the drill rod 32 when drilling is active to flush dust out of the hole that is being drilled. As shown in FIG. 6, the auxiliary service line 70 may include a valve 72, such as a ball valve or another type of valve, that is opened and closed by the operator as needed using the operator control 68. Alternatively, or additionally, the valve 72 may be automatically controlled. As shown in FIG. 6, the auxiliary service line 70 may also include a pressure sensor 74 that monitors the pressure (i.e., the variable auxiliary pressure) of the compressed air flowing through the service line 70.

In some implementations, the compressed air stored in the reservoir 42 may be used to support multiple fixed-pressure auxiliary operations, multiple variable-pressure auxiliary operations, and/or multiple standby operations. As yet another possibility, the compressed air stored in the reservoir may be used to support only one or more fixed-pressure auxiliary operations, variable-pressure auxiliary operations, or standby operations. Variations such as these also fall within the scope of the present disclosure.

As shown in FIG. 6, an electronic control system 77 may regulate the open or closed position of the inlet valve 38 so that the reservoir 42 is charged at the target reservoir pressure that is needed carry out the standby operation(s) and the active auxiliary operation(s) of the machine 10. Specifically, the electronic control system 77 may adjust the open or closed position of the inlet valve 38 when the actual reservoir pressure deviates from the target reservoir pressure. The electronic control system 77 may include the electronic actuator 44 and an electronic control module (ECM) 80 that is in electronic communication with the electronic actuator 44 for control thereof. Specifically, the ECM 80 may control the electronic actuator 44 (and the inlet valve 38) so as to minimize a pressure difference between the target reservoir pressure and the actual reservoir pressure. To determine the target reservoir pressure and to monitor the actual reservoir pressure, the ECM 80 may also be in electronic communication with the pressure sensors 54 and 74 and the operator control 68 (see further details below). Optionally, the ECM 80 may also be in electronic or wireless communication with a pressure input control 82 that permits an operator to input set pressure values for the standby operation and/or the auxiliary operation(s) (see further details below). The pressure input control 82 may be any appropriate input device such as a computer terminal, a hand-held device, an external storage device, or an electronic adjustment device (e.g., an analog rotary dial, a rheostat, etc.) connected to the ECM 80.

As shown in FIG. 6, the ECM 80 may include a microprocessor 84 for executing specified programs involved in regulating the inlet valve 38. The microprocessor 84 may include a memory 86, such as a read only memory (ROM) 88 that may store a program or several programs, as well as a random access memory (RAM) 90 that may serve as a working memory for use in executing the programs stored in the memory 86.

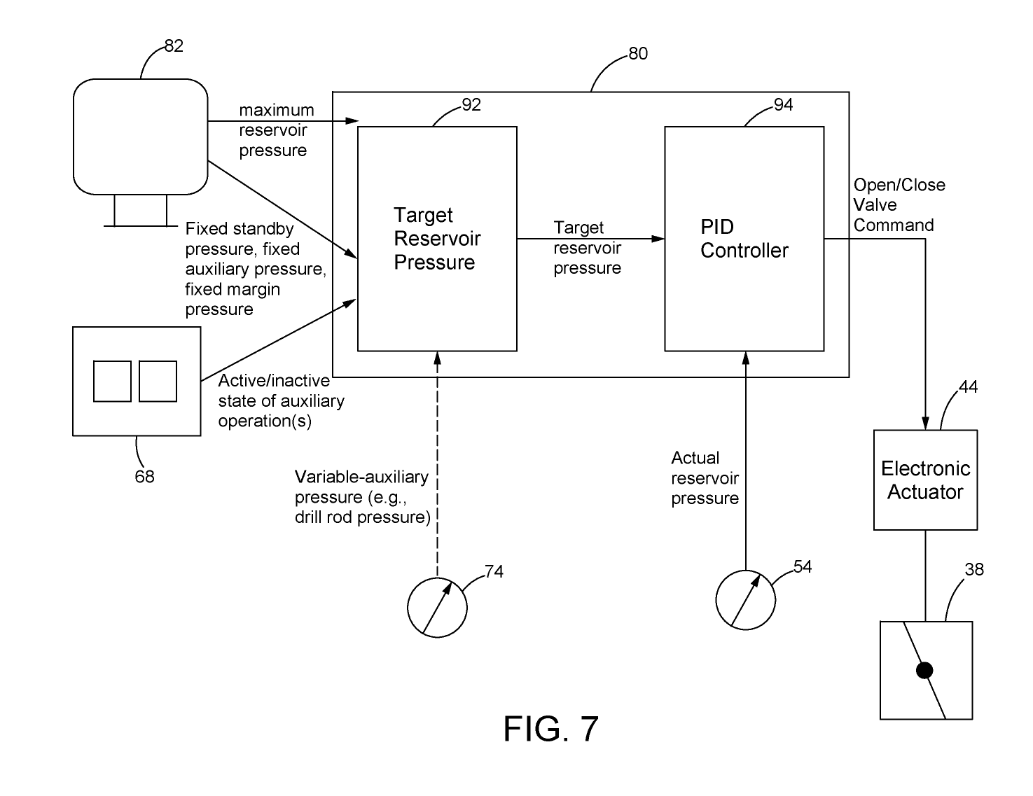

FIG. 7 illustrates a strategy for regulating the open or closed position of the inlet valve 38 as implemented by the ECM 80. The ECM 80 may include a target reservoir pressure module 92 that determines the target reservoir pressure, and a proportional-integral-derivative (PID) controller 94 that transmits an open or close valve command to the electronic actuator 44 based on the difference between the target reservoir pressure and the actual reservoir pressure. As shown in FIG. 7, to determine the target reservoir pressure, the target reservoir pressure module 92 may receive input from the operator control 68 indicating the active or inactive state of the fixed-pressure auxiliary operation(s) and the variable-pressure auxiliary operation(s). In addition, when the variable-pressure auxiliary operation is active, the target reservoir pressure module 92 may receive signals from the pressure sensor 74 in the auxiliary service line 70 indicating the variable auxiliary pressure. From the pressure input control 82, the target reservoir pressure module 92 may receive set pressure values for the fixed standby pressure, the fixed auxiliary pressure, and a fixed margin pressure that is applied to the variable auxiliary pressure when the variable-pressure auxiliary operation is active. In addition, from the pressure input control 82, the target reservoir pressure module 92 may receive a set value for the maximum reservoir pressure which is reflective of the maximum pressure capacity of the reservoir 42. Alternatively, one or more of the set pressure values (i.e., the set pressure values for the fixed standby pressure, the fixed auxiliary pressure, the fixed margin pressure, and the maximum reservoir pressure) may be stored in the memory of the ECM 80. Based on the set pressure values, the variable auxiliary pressure, and the active or inactive states of the fixed-pressure auxiliary operation and the variable-pressure auxiliary operation, the target reservoir pressure module 92 may determine a value for the target reservoir pressure and output the target reservoir pressure to the PID controller 94 (see further details below).

The PID controller 94 may receive signals indicative of the actual reservoir pressure from the pressure sensor 54, and may determine if a pressure difference exists between the actual reservoir pressure and the target reservoir pressure. If a pressure difference is detected, the PID controller 94 may transmit an open or close valve command to the electronic actuator 44 so that the electronic actuator 44 opens or closes the inlet valve 38 to increase or decrease the pressure in the reservoir 42 until the actual reservoir pressure matches or closely matches the target reservoir pressure.

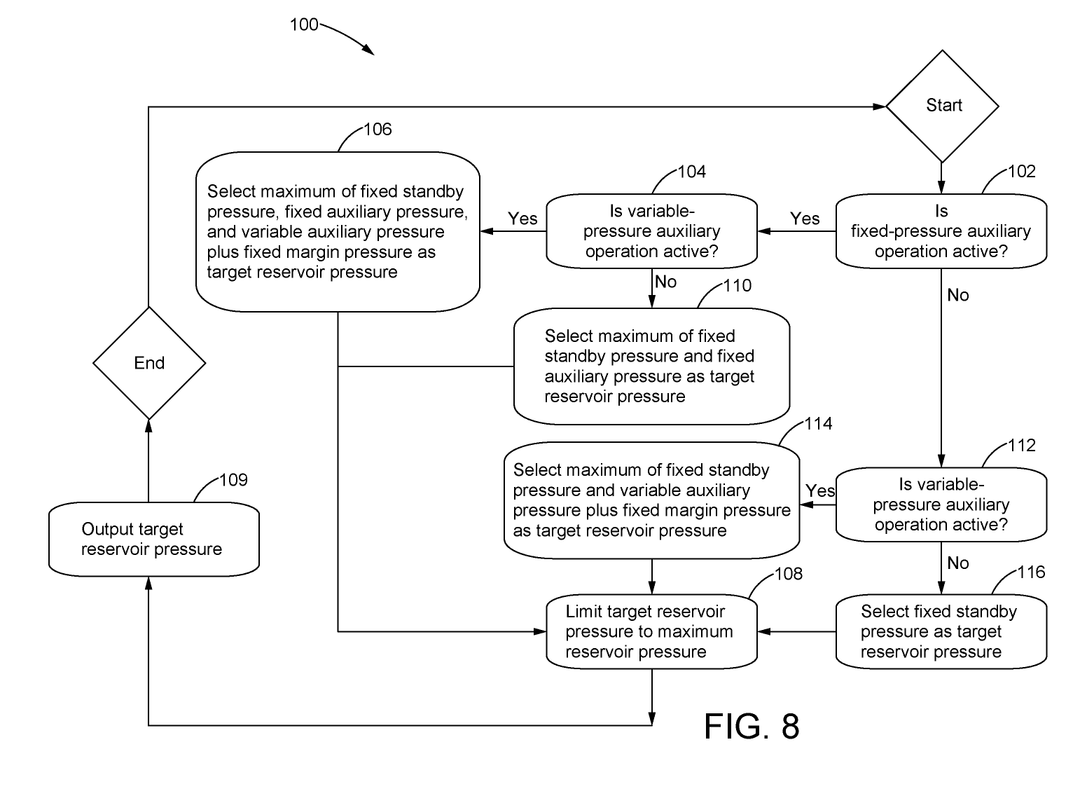

Turning now to FIG. 8, an exemplary method 100 for determining the target reservoir pressure is shown. In some implementations, the exemplary method may be performed by the target reservoir pressure module 92 (or module 92), or by another element or component of the ECM 80 alone or in conjunction with the module 92. In this regard, the target reservoir pressure module 92 may determine whether the fixed-pressure auxiliary operation is active based on input from the operator control 68 (block 102). For example, if the fixed-pressure auxiliary operation is the delivery of the compressed air to the dust collector 36 for filter cleaning, the module 92 may receive signals from the operator control 68 indicating whether the cleaning cycle is active. If the fixed-pressure auxiliary operation is active, the module 92 may determine if the variable-pressure auxiliary operation is active (block 104). If, for example, the variable-pressure auxiliary operation is the delivery of compressed air to the drill rod 32, the module 92 may receive signals from the operator control 68 and/or the pressure sensor 74 to determine when drilling is active. For example, the module 92 may receive signals from the pressure sensor 74 indicating that drilling is active when the pressure sensor 74 detects pressure in the auxiliary service line 70.

If both the fixed-pressure auxiliary operation and the variable-pressure auxiliary operation are active (e.g., both the cleaning cycle and drilling are active), the module 92 may select the maximum pressure out of the fixed standby pressure, the fixed auxiliary pressure, and the variable auxiliary pressure plus the fixed margin pressure as the target reservoir pressure (block 106). As explained above, the fixed standby pressure, the fixed auxiliary pressure, and the fixed margin pressure that is applied to the variable auxiliary pressure may be set values that are stored in the memory of the ECM 80, or set values that are input by the operator into the ECM 80 using the pressure input control 82. In addition, the module 92 may receive signals from the pressure sensor 74 indicating the variable auxiliary pressure in the auxiliary service line 70 (also see FIG. 7). As an illustrative example, if the set value for the fixed standby pressure is 50 pounds per square inch (psi), the set value for the fixed auxiliary pressure is 70 psi, the variable auxiliary pressure detected by the pressure sensor 74 is 25 psi, and the set value for the fixed margin pressure is 20 psi, the module 92 may select 70 psi as the target reservoir pressure as it is the maximum pressure of 50 psi, 70 psi, and 45 psi (the sum of 25 psi plus 20 psi). The module 92 may then limit the target reservoir pressure to the maximum reservoir pressure to prevent over-pressurizing the reservoir 42 (block 108). For instance, if the target reservoir pressure is above the maximum reservoir pressure, the module 92 may reduce the target reservoir pressure to the maximum reservoir pressure. If, however, the target reservoir pressure is below the maximum reservoir pressure, the target reservoir pressure will not be adjusted. The module 92 may output the target reservoir pressure to the PID controller 94 (block 109).

Alternatively, if the fixed-pressure auxiliary operation is active and the variable-pressure auxiliary operation is inactive (e.g., the cleaning cycle is active, and drilling is inactive), the module 92 may select the maximum pressure out of the fixed standby pressure and the fixed auxiliary pressure as the target reservoir pressure (block 110), and may limit the target reservoir pressure to the maximum reservoir pressure if the target reservoir pressure is above the maximum reservoir pressure (block 108). The module 92 may then output the target reservoir pressure to the PID controller 94 (block 109).

If the fixed-pressure auxiliary operation is inactive, the module 92 may determine whether the variable-pressure auxiliary operation is active (block 112). If the variable-pressure auxiliary operation is active, the module 92 may select the maximum pressure out of the fixed standby pressure and the variable auxiliary pressure (received from the pressure sensor 74) plus the fixed margin pressure as the target reservoir pressure (block 114), and may limit the target reservoir pressure to the maximum reservoir pressure if the target reservoir pressure is above the maximum reservoir pressure (block 108). The target reservoir pressure may then be output to the PID controller 94 (block 109).

If both the fixed-pressure auxiliary operation and the variable-pressure auxiliary operation are inactive, the module 92 may select the fixed standby pressure as the target reservoir pressure (block 116), and may limit the target reservoir pressure to the maximum reservoir pressure if the target reservoir pressure is above the maximum reservoir pressure (block 108). The target reservoir pressure may then be output to the PID controller 94 (block 109). The method of FIG. 8 may be repeated throughout the operation of the machine 10 so as to adjust the target reservoir pressure as the active states of the auxiliary operations vary. It is noted that the method of FIG. 8 is exemplary, and that two or more of the blocks 102, 104, 106, 108, 109, 110, 112, 114, and 116 may be carried out in different orders or simultaneously.

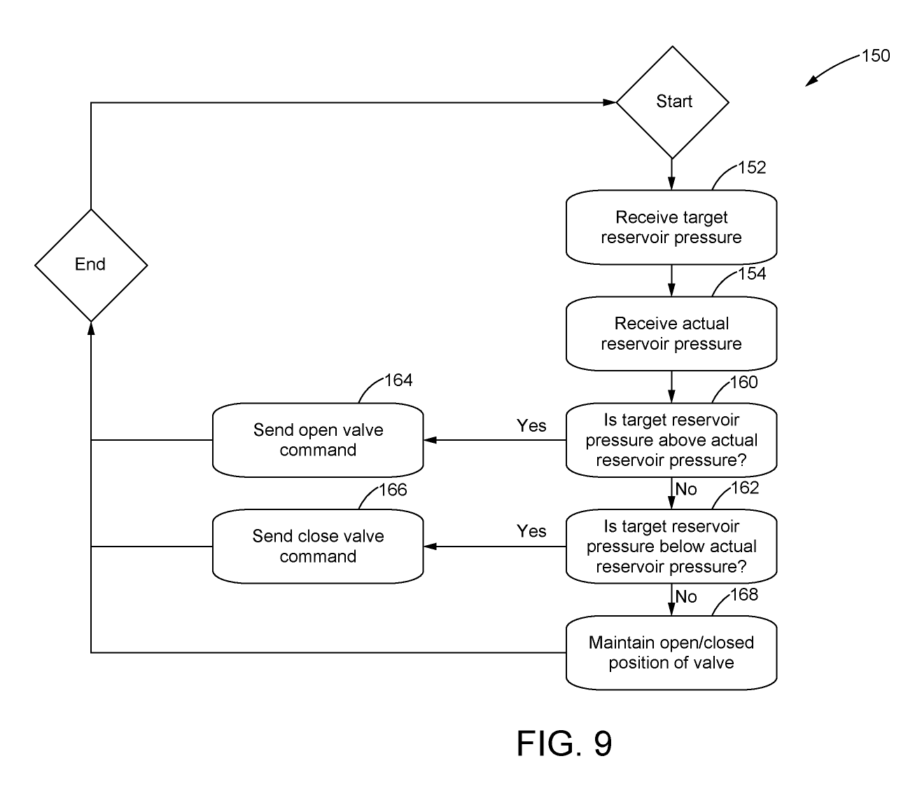

Referring now to FIG. 9, an exemplary method 150 for controlling an open or closed position of the inlet valve 38 as implemented by the PID controller 94 (or another element of the ECM 80 alone or in conjunction with the PIC controller 94) is shown. The method 150 may begin at blocks 152 and 154 when the PID controller 94 receives the target reservoir pressure from the module 92 and the actual reservoir pressure from the pressure sensor 54, with the blocks 152 and 154 being carried out in any order or simultaneously. The PID controller 94 may compare the actual reservoir pressure to the target reservoir pressure according (blocks 160 and 162). Specifically, the PID controller 94 may determine if there is any pressure difference between the target reservoir pressure and the actual reservoir pressure, and determine if the target reservoir pressure is above (block 160) or below (block 162) the actual reservoir pressure. If the target reservoir pressure is above the actual reservoir pressure (or, stated in another way, if the actual reservoir pressure is below the target reservoir pressure), the pressure of the compressed air in the reservoir 42 may not be sufficient to support the standby operation(s) and/or the active auxiliary operation(s) of the machine 10. As such, the PID controller 94 may transmit an open valve command to the electronic actuator 44 (block 164). Based on the open valve command, the electronic actuator 44 opens the inlet valve 38 by a magnitude that is proportional to the pressure difference between the target reservoir pressure and the actual reservoir pressure. As a result, the actual reservoir pressure may rise to the target reservoir pressure as more compressed air flows from the air compressor 22 into the reservoir 42.

If the target reservoir pressure is below the actual reservoir pressure (or, stated in another way, if the actual reservoir pressure is above the target reservoir pressure), the pressure of the compressed air in the reservoir 42 may be higher than is needed to carry out the standby operation(s) and the active auxiliary operation(s) of the machine 10. Accordingly, the PID controller 94 may transmit a close valve command to the electronic actuator 44 (block 166). Based on the close valve command, the electronic actuator 44 closes the inlet valve 38 by a magnitude that is proportional to the pressure difference between the actual reservoir pressure and the target reservoir pressure. Consequently, the actual reservoir pressure may fall to a level that matches or more closely matches the target reservoir pressure. Alternatively, if the actual reservoir pressure matches the target reservoir pressure, the position of the inlet valve 38 may be maintained (block 168). It will be understood that the method 150 of FIG. 9 is exemplary, and that one or more of the blocks 152, 154, 160, 162, 164, 166, and 168 may be carried out in any order or simultaneously.

The PID controller 94 may repeat the method 150 continuously throughout the operation of the machine 10 to assure that the actual reservoir pressure in the reservoir 42 corresponds to the target reservoir pressure needed to perform the standby operation(s) and the active auxiliary operation(s) of the machine 10. Those with ordinary skill in the art will appreciate that the methods of FIGS. 8-9 may be modified to accommodate more or fewer standby operations, and/or more or fewer fixed-pressure or variable-pressure auxiliary operations. Variations such as these also fall within the scope of the present disclosure.

### INDUSTRIAL APPLICABILITY

In general, the teachings of the present disclosure may find applicability in many industries including, but not limited to, construction, mining, agriculture, and automotive industries. More specifically, the present disclosure may find applicability in any industry using machines that rely on compressed air to perform operations that are not constantly active.

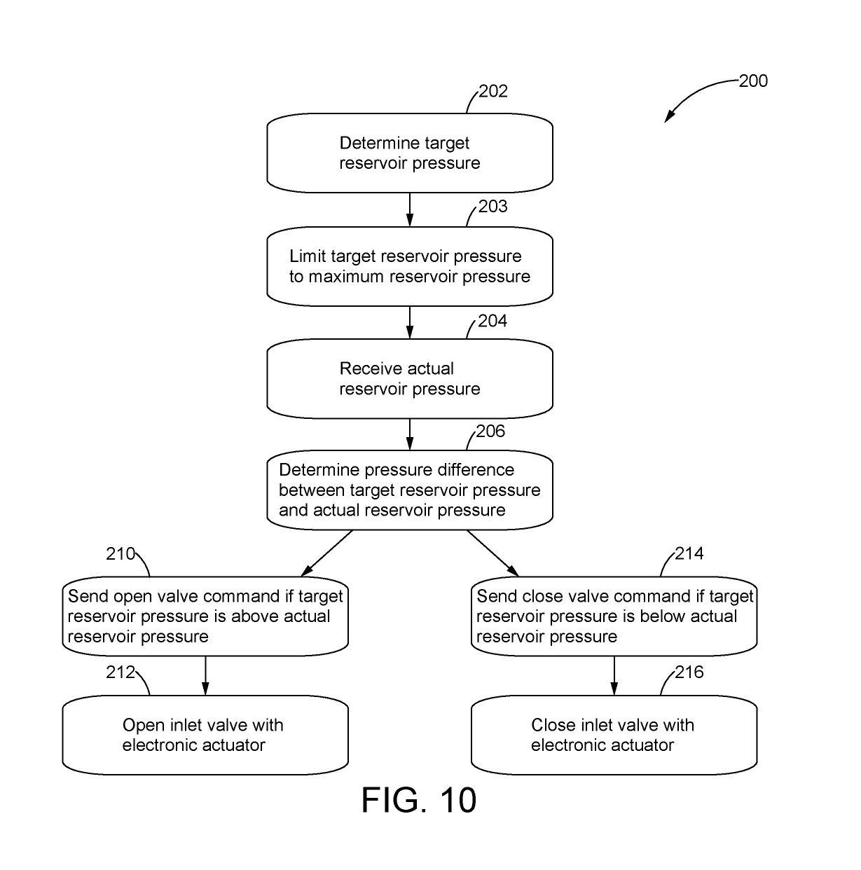

Referring to FIG. 10, an exemplary method 200 of regulating the position of the inlet valve 38 using the electronic control system 77 is shown. Namely, the exemplary method may be performed by the electronic actuator 44 and the ECM 80, including the target reservoir pressure module 92 and the PID controller 92 and/or other elements or components of the ECM 80. In this regard, the ECM 80 of the electronic control system 77 may determine the target reservoir pressure of the reservoir 42 (block 202). As explained above, the block 202 may involve determining the active or inactive states of the fixed-pressure auxiliary operation(s) and the variable-pressure auxiliary operation(s) of the machine 10 (see FIG. 8). In addition, the block 202 may further involve selecting the target reservoir pressure as a maximum of a set value for the fixed standby pressure, a set value for the fixed auxiliary pressure if the fixed-pressure auxiliary operation is active, and the variable auxiliary pressure (as monitored by the pressure sensor 74) plus the fixed margin pressure if the variable-pressure auxiliary operation is active (see FIG. 8). By applying the fixed margin pressure to the variable auxiliary pressure, the electronic control system 77 may charge the reservoir 42 to a pressure that is slightly above the pressure demand of the variable-pressure auxiliary operation. The ECM 80 may limit the target reservoir pressure to the maximum reservoir pressure if the target reservoir pressure is above the maximum reservoir pressure to avoid over-pressurizing the reservoir 42 (block 103).

The ECM 80 may receive the actual reservoir pressure from the pressure sensor 54 (block 204) (see, for example, FIG. 7 and the corresponding description), and may determine the pressure difference (if any) between the target reservoir pressure and the actual reservoir pressure (block 206). If the target reservoir pressure is above the actual reservoir pressure (i.e., the actual reservoir pressure is below the target reservoir pressure), the ECM 80 may transmit an open valve command to the electronic actuator 44 (block 210), causing the electronic actuator 44 to open the inlet valve 38 by a degree that is proportional to the pressure difference between the target reservoir pressure and the actual reservoir pressure (block 212). As a result, the actual reservoir pressure in the reservoir 42 may increase to a level that approaches or reaches the target reservoir pressure. Alternatively, the ECM 80 may transmit a close valve command to the electronic actuator 44 if the target reservoir pressure is below the actual reservoir pressure (i.e., the actual reservoir pressure is above the target reservoir pressure) (block 214), causing the electronic actuator 44 to close the inlet valve 38 by a degree that is proportional to the pressure difference between the actual reservoir pressure and the target reservoir pressure (block 216). As a result, the actual reservoir pressure in the reservoir 42 may lower to a level that approaches or reaches the target reservoir pressure.

The electronic control system disclosed herein dynamically regulates the flow of compressed air into the reservoir according to the fluctuating compressed air demands of the machine. In particular, the electronic control system of the present disclosure regulates the position of the inlet valve to the air compressor so that the reservoir is charged with compressed air to a level sufficient to perform the standby operation(s) and any active auxiliary operation(s) of the machine. Moreover, the electronic control system opens and closes the inlet valve by a degree that is proportional to any pressure difference between the target reservoir pressure and the actual reservoir pressure, so that the amount of compressed air that is produced by the air compressor is proportional to the compressed air demands of the machine. As the air compressor is driven by the engine and places a power burden on the engine, such proportional control of the inlet valve position may avoid overworking the air compressor and placing unnecessary loads on the engine. For example, if implemented on a track drill machine or a rotary drill machine, the electronic control system avoids over-pressurizing the reservoir when compressed air needs are low, such as when starting (or “collaring”) a hole with the drill rod. This may result in beneficial load reductions on the engine and fuel savings over pneumatically-controlled systems of the prior art which may open the inlet valve completely (or nearly completely) and over-pressurize the reservoir when drilling commences. In addition, if implemented on a track drill machine or a rotary drill machine, the electronic control system may ensure that standby pressure requirements for lubrication of the air compressor, and auxiliary pressure requirements for dust collector filter cleaning are satisfied by the compressed air system without placing unnecessary loads on the engine.

It is expected that the technology disclosed herein may find wide industrial applicability in a wide range of areas such as, but not limited to, construction, automotive, marine, mining, agriculture, and earth-moving equipment applications.

What is claimed is:

1. A compressed air system for a machine, the compressed air system comprising:
an air compressor having an inlet;
an inlet valve configured to regulate a flow of air to the inlet of the air compressor;
a reservoir configured to store compressed air generated by the air compressor;
a reservoir pressure sensor configured to monitor an actual reservoir pressure of the compressed air stored in the reservoir; and
an electronic control system configured to regulate a position of the inlet valve, the electronic control system including an electronic control module (ECM) in electronic communication with the reservoir pressure sensor and an electronic actuator operatively associated with the inlet valve to adjust the position of the inlet valve, the ECM being configured to:
transmit an open valve command to the electronic actuator when the actual reservoir pressure is below a target reservoir pressure so that the electronic actuator at least partially opens the inlet valve, and
to transmit a close valve command to the electronic actuator when the actual reservoir pressure is above the target reservoir pressure so that the electronic actuator at least partially closes the inlet valve.

2. The compressed air system of claim 1, wherein the compressed air stored in the reservoir is used to perform at least one standby operation that is performed constantly during the operation of the machine at a fixed standby pressure.

3. The compressed air system of claim 2, wherein the compressed air stored in the reservoir is further used to perform:
at least one fixed-pressure auxiliary operation that is performed intermittently during the operation of the machine at a fixed auxiliary pressure, and
at least one variable-pressure auxiliary operation that is performed intermittently during the operation of the machine at a variable auxiliary pressure.

4. The compressed air system of claim 3, wherein the ECM is configured to select the target reservoir pressure as a maximum of the fixed standby pressure and the fixed auxiliary pressure when the fixed-pressure auxiliary operation is active and the variable-pressure auxiliary operation is inactive.

5. The compressed air system of claim 3, wherein the ECM is configured to select the target reservoir pressure as a maximum of the fixed standby pressure, the fixed auxiliary pressure, and the variable auxiliary pressure plus a fixed margin pressure when both the fixed-pressure auxiliary operation and the variable-pressure auxiliary operation are active.

6. The compressed air system of claim 3, wherein the ECM is configured to select the target reservoir pressure as the fixed standby pressure when both the fixed-pressure auxiliary operation and the variable-pressure auxiliary operation are inactive.

7. The compressed air system of claim 1, wherein the ECM includes a proportional-integral-derivative (PID) controller configured to:
determine a pressure difference between the target reservoir pressure and the actual reservoir pressure,
transmit the open valve command to the electronic actuator when the target reservoir pressure is above the actual reservoir pressure so that the electronic actuator opens the inlet valve by a degree that is proportional to the pressure difference, and
transmit the close valve command to the electronic actuator when the target reservoir pressure is below the actual reservoir pressure so that the electronic actuator closes the inlet valve by a degree that is proportional to the pressure difference.

8. The compressed air system of claim 7, wherein the PID controller is further configured to:
determine a pressure difference between the actual reservoir pressure and a maximum reservoir pressure, and
transmit the close valve command to the electronic actuator when the actual reservoir pressure is at or above the maximum reservoir pressure.

9. The compressed air system of claim 1, wherein the inlet valve is a butterfly valve.

10. The compressed air system of claim 1, further comprising a mechanical link linking the electronic actuator to the inlet valve.

11. The compressed air system of claim 1, wherein the machine is one of a track drill machine or a rotary drill machine.

12. A method for electronically controlling an inlet valve to an air compressor of a compressed air system of a machine, the compressed air system including a reservoir configured to store compressed air from the air compressor, and a reservoir pressure sensor configured to monitor an actual reservoir pressure of the compressed air stored in the reservoir, the method comprising:
determining a target reservoir pressure for the compressed air stored in the reservoir;
determining a pressure difference between the target reservoir pressure and the actual reservoir pressure;
transmitting an open valve command to an electronic actuator when the actual reservoir pressure is below the target reservoir pressure so that the electronic actuator opens the inlet valve by a degree that is proportional to the pressure difference; and
transmitting a close valve command to the electronic actuator when the actual reservoir pressure is above the target reservoir pressure so that the electronic actuator closes the inlet valve by a degree that is proportional to the pressure difference.

13. The method of claim 12, wherein the compressed air stored in the reservoir is used to perform:
at least one standby operation that is performed constantly during the operation of the machine at a fixed standby pressure,
at least one fixed-pressure auxiliary operation that is performed intermittently during the operation of the machine at a fixed auxiliary pressure, and
at least one variable-pressure auxiliary operation that is performed intermittently during the operation of the machine at a variable auxiliary pressure.

14. The method of claim 13, wherein determining the target reservoir pressure comprises selecting the target reservoir pressure as the fixed standby pressure when the fixed-pressure auxiliary operation and the variable-pressure auxiliary operation are inactive.

15. The method of claim 13, wherein determining the target reservoir pressure comprises selecting the target reservoir pressure a maximum of the fixed standby pressure and the fixed auxiliary pressure when the fixed-pressure auxiliary operation is active and the variable-pressure auxiliary operation is inactive.

16. The method of claim 13, wherein determining the target reservoir pressure comprises selecting the target reservoir pressure as a maximum of the fixed standby pressure and the variable auxiliary pressure plus a fixed margin pressure when the variable-pressure auxiliary operation is active and the fixed-pressure auxiliary operation is inactive.

17. The method of claim 13, wherein determining the target reservoir pressure comprises selecting the target reservoir pressure as a maximum of the fixed standby pressure, the fixed auxiliary pressure, and the variable auxiliary pressure plus the fixed margin pressure when the fixed-pressure auxiliary operation and the variable-pressure auxiliary operation are both active.

18. The method of claim 17, further comprising receiving a signal indicating the actual reservoir pressure from the reservoir pressure sensor prior to determining the pressure difference between the target reservoir pressure and the actual reservoir pressure.

19. The method of claim 17, wherein determining the target reservoir pressure further comprises limiting the target reservoir pressure to a maximum reservoir pressure.

20. A drill machine, the drill machine comprising:
an internal combustion engine;
at least one drill rod;
a compressed air system configured to deliver compressed air to the drill rod when drilling is active, the compressed air system including an air compressor driven by the internal combustion engine and having an inlet, a butterfly valve configured to regulate a flow of air into the inlet, a reservoir configured to store the compressed air generated by the air compressor, and a reservoir pressure sensor configured to monitor an actual reservoir pressure of the compressed air stored in the reservoir;
an electronic actuator operatively associated with the butterfly valve to control a position of the butterfly valve; and
an electronic control module (ECM) in electronic communication with the reservoir pressure sensor and the electronic actuator, the ECM being configured to:
determine a target reservoir pressure,
transmit an open valve command to the electronic actuator when the actual reservoir pressure is below the target reservoir pressure so that the electronic actuator at least partially opens the butterfly valve, and
transmit a close valve command to the electronic actuator when the actual reservoir pressure is above the target reservoir pressure so that the electronic actuator at least partially closes the butterfly valve.
